(19) United States
(12) Patent Application Publication
(10) Pub. No.: US 2008/0235060 A1
(43) Pub. Date: Sep. 25, 2008

(54) Precise medical information retrieval

(76) Inventor: Anuthep Benja-Athon, New York, NY (US)

Correspondence Address: ANUTHEP BENJA-ATHON, MD., 210 E 36TH St,, NEW YORK, NY, 10016, US

(21) Appl. No.: 12/156,674

(22) Filed: Jun. 4, 2008

Related U.S. Application Data
(63) Continuation-in-part of application No. 12/069,409, filed on Feb. 11, 2008.
Application No. 12/069,409 is a continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/114,763, filed on Apr. 27, 2005.
Application No. 11/114,763 is a continuation-in-part of application No. 11/973,823, filed on Oct. 10, 2007.
Application No. 11/973,823 is a continuation-in-part of application No. 11/973,866, filed on Oct. 11, 2007.
Application No. 11/973,866 is a continuation-in-part of application No. 11/543,895, filed on Oct. 6, 2006.
Application No. 11/543,895 is a continuation-in-part of application No. 11/510,820, filed on Aug. 28, 2006.
Application No. 11/510,820 is a continuation-in-part of application No. 11/477,121, filed on Jun. 29, 2006.
Application No. 11/477,121 is a continuation-in-part of application No. 11/431,046, filed on May 10, 2006.
Application No. 11/431,046 is a continuation-in-part of application No. 11/022,410, filed on Dec. 27, 2004, now abandoned.
Application No. 11/022,410 is a continuation-in-part of application No. 11/074,236, filed on Mar. 7, 2005.

(51) Int. Cl. G06F 19/00

(52) U.S. Cl. 705/3

(57) ABSTRACT

A method of using the outcomes of relating the headings in the first and second templates to the information on diseases, illnesses, health and health-care on patients generated and/or selected by physicians wherein the relations of headings and information are input and stored in the database or databases and the headings and information are used to effect the retrievals and displays of more information on the information for and viewable by patients and physicians.

This application is a continuation-in-part of Ser. No. 12/069,409 entitled The filing of health and health-care data filed Feb. 11, 2008, a continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/543,895 entitled Vital elements of speech recognition filed Oct. 6, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/431,046 entitled A system of health-care information management filed Nov. 2, 2006, and a continuation-in-part of Ser. No. 11/022,410 entitled Physicians' way of information productions filed Dec. 27, 2004, a continuation-in-part of Ser. No. 11/074,236 entitled A system of management of health-care resources filed Mar. 7, 2005 which are pending.

### FIELD OF INVENTION

A method of retrieving and displaying information on the data generated by physicians.

### BACKGROUND OF THE INVENTION

The present system of searching information on health, health-care, diseases and illnesses by patients in the libraries or using the Internet is relatively random, extremely inefficient and time consuming and wasting of resources and loaded with errors, inaccurate information and misunderstandings. Even when information—accurate, useful or otherwise—are found by patients, the information most often neither fit, relate nor pertain to the diseases, illnesses and health of concern to the patients. When patients and their families and/or relatives are told of patients' diseases and illnesses said searches are launched and used with dubious results supra. Moreover, in said system, physicians neither can efficiently and optimally explain nor communicate useful and/or detailed information on said information to the patients and related. These problems and inefficiencies significantly contribute to the current health-care crises and inefficiencies resulting in misunderstandings and conflicts between patients and their physicians, costly and time consuming litigations, escalating health-care costs for health-care consumers, buyers and providers and increase morbidity and mortality of patients, etc.

There is no prior art because the present invention provides a unique innovation which exists only because of the pending patent applications supra of the present patent applicant and his co-applicants.

Therefore, the present invention—an artificial intelligent system—solves said problems and crises by showing the medical, health and health-care information representing also the thoughts and thinking processes of physicians who provide health-care for their patients whom are directly, expeditiously and precisely shown the health and health-care data and information explaining, supporting and/or detailing the diseases, illnesses and/or health and health-care issues and/or matters affecting said patients. The benefits are immense for all people.

### SUMMARY OF THE INVENTION

The understandings and acquisitions of health and health-care data and information on diseases, illnesses and health of patients and physician-provided health-care by patients are inefficient, random, inaccurate and, often, erroneous in the current system. On the contrary, the present invention provides accurate and precise information on diseases, illnesses, health and health-care of patients by their physicians.

The present invention provides a method of using the outcomes of relating the headings in the first and second templates to the information on diseases, illnesses, health and health-care of patients generated and/or selected by physicians wherein the related headings and information are input and stored in the database or databases of the computers and/or server or servers of a network or networks of computers and servers and said related headings and information are used to effect the retrievals and displays of the details of said information on diseases, illnesses, health and health-care for and viewable by patients and physicians.

### DESCRIPTION OF THE PREFERRED EMBODIMENTS

The present invention provides a method of relating first words, terms and phrases in a first template comprises headings such as, but not limited, the following in Illustration 1 and second templates of words, terms and phrases which are linked to Pop-up Lists of words, terms, phrases representing health, health-care, medical and surgical data and information use by physicians of all medical and surgical specialties or practices.

### Illustration 1:

### Evaluation

### Chief Complaint

### Review of Systems

### Physical Examination

### Diagnosis

### Differential Diagnosis

### Laboratory

### Assessment and Plan

### Treatment

### Surgery

### Medication

### Follow up

### Recommendation

### Referral

Said headings appear on the viewing screens using computer programs and software including the browsers or the like. In said Illustration 1, using computer keyboards, physicians of about 80 medical and surgical specialties or practices can type words, terms, phrases and sentences representing and pertinent to diseases, illnesses, disorders, health and health-care information on their patients to the right of the headings in the first templates as they appear on the viewing screens viewable by physicians. However, better yet, one of the preferred embodiments of the present invention lets physicians use second templates and related Pop-up Lists or third templates comprising words, terms and phrases which are selected and clicked from the Pop-up Lists infra by physicians causing selected words, terms and phrases to be appropriately placed to the right of or, in other words, coupled to the appropriate headings in said first templates.

In the second templates—see Illustration 2 infra—the underlined headings are used by all physicians of about 80 medical and surgical specialties such as neurologists, internists, rheumatologists, gastroenterologists, neurosurgeons, general surgeons, allergists, immunologists, ophthalmologists, etc. However, each Pop-up List links to each heading in the second templates comprises words, terms, phrases representing health, health-care, medical and surgical data and information on patients unique to or pertinent to individual medical and surgical specialties or practices except for the Evaluation heading which can be used by all physicians of all medical and surgical specialties or practices. For example, for neurology specialty, neurologists will see one of the preferred embodiments of the present invention wherein the left column infra represents the first template comprises said headings and the right column infra represents the second template. A neurologist, for example, using the second template can place cursor using computer mouse to place blinking “I”s or the like to the right of the heading Evaluation in the first template and proceeds to click Evaluation in the second template to cause the display of a Pop-up list or a third template comprising about 50-100 words, terms and phrases pertinent to Evaluation such as, but not limited to, Consultation, Simple consultation, Intermediate consultation, Comprehensive consultation, Visit, Office visit, Simple office visit, Intermediate office visit, Comprehensive office visit, etc. as represent by “etc.” in ILLUSTRATION 2:

| Evaluation I | Evaluation | Pop-up List |
|---|---|---|
| Chief Complaint | Chief Complaint | Consultation, etc. |
| Review of Systems | Review of Systems | |
| Physical Examination | Physical Examination | |
| Diagnosis | Diagnosis | |
| Differential Diagnosis | Differential Diagnosis | |
| Laboratory | Laboratory | |
| Assessment and Plan | Assessment and Plan | |
| Treatment | Treatment | |
| Surgery | Surgery | |
| Medication | Medication | |
| Follow up | Follow up | |
| Recommendation | Recommendation | |
| Referral | Referral | |
| Submit | Cancel | |

A physician—a neurologist—can select and click the word Consultation in said Pop-up List or a third template, the selected word Consultation is placed to the right of Evaluation in the first template as illustrate in the left column in the Illustration 3 infra.

Furthermore, for the purpose of describing a preferred embodiment of the present invention, by skipping three headings to Diagnosis, a neurologist, in this description, can place a cursor using a computer mouse to place a blinking “I” or the like to the right of the heading Diagnosis and proceed to click Diagnosis to cause the display of a Pop-up List or a third template of thousands of words, terms and phrases from A-Z representing or pertinent to neurological Diagnosis, diseases, illnesses and disorders such as, but not limited to, Abducens nerve injury to Zoster, and wherein “etc.” representing said thousands of neurological words, terms and phrases as shown in ILLUSTRATION 3:

| Evaluation Consultation | Evaluation | Pop-up List |
|---|---|---|
| Chief Complaint | Chief Complaint | Abducens nerve |
| | | injury, etc. |
| Review of Systems | Review of Systems | |
| Physical Examination | Physical Examination | |
| Diagnosis I | Diagnosis | |
| Differential Diagnosis | Differential Diagnosis | |
| Laboratory | Laboratory | |
| Assessment and Plan | Assessment and Plan | |
| Treatment | Treatment | |
| Surgery | Surgery | |
| Medication | Medication | |
| Follow up | Follow up | |
| Recommendation | Recommendation | |
| Referral | Referral | |
| Submit | Cancel | |

By the neurologist selecting a diagnosis Bell's palsy (being a disease in said Pop-up List supra), the result of said selection and clicking produce the following result in the ILLUSTRATION 4:

| Evaluation Consultation | Evaluation | Pop-up List |
|---|---|---|
| Chief Complaint | Chief Complaint | Abducens nerve |
| | | injury, etc. |
| Review of Systems | Review of Systems | |
| Physical Examination | Physical Examination | |
| Diagnosis Bell's palsy | Diagnosis | |
| Differential Diagnosis | Differential Diagnosis | |
| Laboratory | Laboratory | |
| Assessment and Plan | Assessment and Plan | |
| Treatment | Treatment | |
| Surgery | Surgery | |
| Medication | Medication | |
| Follow up | Follow up | |
| Recommendation | Recommendation | |
| Referral | Referral | |
| Submit | Cancel | |

Having achieved Evaluation Consultation and Diagnosis Bell's palsy—two pairs of coupled words, although another preferred embodiment of the present prevention has the computer programs permit the selecting, clicking, relating or associating as many words, terms and phrases including adjectives such as, but not limited, to indication of the anatomical details such as, but not limited to, left, right, ipsilateral, contralateral, anterior, superior, from the Pop-up List to couple with each preceding heading. The selections of other words, terms, phrases in the Pop-up Lists or third templates relating to other headings are achieved as taught supra. Thus, a representation of one of the immensely large outcomes of the preferred embodiments of the present invention is shown in ILLUSTRATION 5:

| Evaluation Consultation | Evaluation |
|---|---|
| Chief Complaint Left face paralysis | Chief Complaint |
| Review of Systems Right ear pain Flu Afebrile | Review of Systems |
| Physical Examination Left facial paralysis | Physical Examination |
| numbess | |
| Diagnosis Left Bell's palsy | Diagnosis |
| Differential Diagnosis Left Otitis media Brain | Differential Diagnosis |
| tumor | |
| Laboratory Brain MRI Lyme disease titer | Laboratory |
| Assessment and Plan Oral medications | Assessment and Plan |
| Treatment None | Treatment |
| Surgery None | Surgery |
| Medication Oral steroid one week Acyclovir | Medication |
| Follow up One week | Follow up |
| Recommendation Call if not better | Recommendation |
| Referral ENT consultation | Referral |
| Submit | Cancel |

Having completed the above generation of health and health-care data on a patient as illustrated in Illustration 5, said neurologist can click “Submit” to permit the computer programs and software to insert said data and said relations into the database or databases.

Further to supra, each Pop-up List or third template comprises words, terms and phrases representing medicine, surgery, health and health-care pertinent and relevant to each related heading in the first and second templates.

The illustrations supra represent one of the preferred embodiments of the present invention applicable to hundreds of thousands of physicians of about 80 medical and surgical specialties or practices generating and entering health and health-care data and information on millions of patients into database or databases of computers and/or servers.

Further to supra, the present invention provides health, health-care, medical and surgical data and information comprising words, terms, phrases, facts, texts, descriptions, writings, bibliographies, references, citations, journals, publications, literatures, and sources, etc., pertain and/or related to the words, terms, phrases and/or sentences present in the Pop-up Lists or third templates encompassing words, terms, phrases and sentences generated and used by said physicians in 80 medical and surgical specialties or practices which are stored in the database or databases of said computers and/or servers. Said data and information are generated by any physicians and input and store in the database or databases and/or generated for and by particular physicians so that the data and information are unique to individual physicians. Further more, first, said data and information are computer-automatically retrieved and displayed to patients and physicians following the physicians submitted said data and information into the database or databases without physicians' or patients' participations. In other words, for example, following said neurologist submitting the above information on a patient in Illustration 5, not only said information is submitted and stored in the database or databases, the innovative computer programs retrieve data and information on words, terms, phrases, facts, texts, descriptions, writings, bibliographies, references, citations, journals, publications, literatures and/or sources on distinguishing and vital words, terms and phrases represent by the Consultation, Facial paralysis, Numbness, Ear pain, Flu, Fever, Bell's palsy, Otitis Media, Brain tumor, Lyme disease, MRI, oral steroid, acyclovir, otolaryngology, Recommendation and other related such as, but not limited to, Warnings, Precautions, Things To Do and Things Not To Do which are presented and displayed as topics for, in this case, said patient and physicians authorized to access said patient's chart. Said preferred embodiment applies to all medical and surgical specialties or practices and physicians.

Said one preferred embodiments of the present invention, using the data and information generated on patients and input by the treating physicians, provides computer-automatically retrievals and display and/or human-initiated and computerized retrievals and displays of data and information on the diseases, illnesses, health and health-care data and information on and related to the patients which explain said diseases, illnesses, health and health-care data and information and related by the treating physician to the patient and patient's other physicians. Said retrieved and displayed information can be posted, using several means for posting standard in and common in the Internet and electronic communications, on the pages such as, but not limited to, pages on the patients' electronic charts—taught by the pending patent applications of the present patent applicant and his co-applicants—viewable and/or clickable to view on the viewing screens of computers and other devices described herein of patients and physicians. Said preferred embodiments and description apply and extend to cover all medical and surgical specialties or practices, physicians and patients.

Furthermore, said data and information can be derived from other sources accessible via the Internet.

The present invention is achieved by the present patent applicant's said innovative computer programs invented by the present patent applicant. Said programs are created using commercially available computer software (plural), programs and computer languages such as, but not limited to, those made and sold by Microsoft Corporation such as, but not limited to, Microsoft SQL, Visual Studio and .Net, Internet Explorer and browsers and databases and derivatives and the like or equivalence, other computer programs and languages, databases and their derivatives which are commonly and routinely use by computer engineers and programmers such as, but not limited to, JAVA and JAVA script, html, PHP, PERL and C languages, etc. and the like and their derivatives.

It is understood that the terms health-care, health care and healthcare have the same meaning and application and that the terms computer server and server have the same meaning and application.

It is understood that the viewing screens used herein are those of the computer monitors, laptops, mobile or wireless electronic devices such as, but not limited to, cellular phones, smart phones and the like and derivatives.

Although various preferred embodiments of the present invention have been described, it will be appreciated by those skilled in the art that adaptations and variations may be made without departing from the spirit and the scope of the claims of the present invention.

1. A method of relating first words and terms in the first and second templates to the second words, terms and phrases in the third templates display on the viewing screens of computers by physicians wherein said physicians view said first words and terms in said first and second templates and relate and select said second words, terms and phrases from said third templates to said first words and terms to effect the relations and associations of said first words and terms and said second words, terms and phrases wherein said relations and associations of said words, terms and phrases are effected and viewable on said display screens by said physicians, wherein said related words, terms and phrases are input into and stored in the database or databases of computers and/or servers in a network or networks of computers and servers and are used to effect the retrievals and displays of medical, surgical, health and health-care data and information relating to said words, terms and phrases on the viewing screens to physicians and patients comprises:
a process of inserting words, terms and phrases representing medical, surgical, diseases, illnesses, disorders, health and health-care information and data into the database or databases of computer server or servers;
a process of storing words, terms and phrases representing medical, surgical, diseases, illnesses, disorders, health and health-care information and data in the database or databases of computer server or servers;
a process of creating template means for displaying said words, terms and phrases on the viewing screens;
a process of placing said words, terms and phrases in said template means for displaying said information and data;
a process of using said template means for means for displaying said words, terms and phrases by physicians;
a process of generating and relating medical, surgical, health and health-care data and information on patients to said words, terms and phrases in said templates by physicians;
a process of selecting and placing medical, surgical, health and health-care data and information to relate to said words, terms and phrases by physicians;
a process of relating generated and selected medical, surgical, health and health-care data and information on patients by physicians to said words, terms and phrases in said templates;
a process of inputting and storing said related data and information and words, terms and phrases in the database or databases;
a process of relating said data and information to related words, terms, phrases, facts, texts, descriptions and writings on diseases, illnesses, disorders, health and health-care of patients;
a process of using said related data and information to retrieve related data and information and related words, terms, phrases, facts, texts, descriptions and writings on diseases, illnesses, disorders, health and health-care of patients for displays on the viewing screens; and
a process of retrieving and displaying related data and information and related words, terms, phrases, facts, texts, descriptions and writings on diseases, illnesses, disorders, health and health-care of patients for displays on the viewing screens.

2. The method according to claim 1 wherein said process of storing medical, surgical, diseases, illnesses, disorders, health and health-care information and data in the database or databases of computer server or servers comprises a process of storing facts, texts, descriptions and writings on diseases, illnesses, disorders, health and health-care in the database or databases of computer server or servers.

3. A method of relating first words and terms in the first and second templates to second words, terms and phrases generated by physicians and/or selected from second words, terms and phrases in the third templates by physicians wherein said words, terms and phrases and texts are present in the database or databases of computers and/or servers of a network or networks of computers and servers wherein selected and related said first and second words, terms and phrases are input into and stored in the database or databases and are used to effect the selections, retrievals and displays of medical, surgical, health and health-care data and information relating to said words, terms and phrases on the viewing screens to physicians and patients comprises:
a process of inserting words, terms and phrases representing medical, surgical, diseases, illnesses, disorders, health and health-care information and data into the database or databases of computer server or servers;
a process of storing words, terms and phrases representing medical, surgical, diseases, illnesses, disorders, health and health-care information and data in the database or databases of computer server or servers;
a process of creating template means for displaying said words, terms and phrases on the viewing screens;
a process of placing said words, terms and phrases in said template means for displaying said information and data;
a process of using said template means for means for displaying said words, terms and phrases by physicians;
a process of generating and relating medical, surgical, health and health-care data and information on patients to said words, terms and phrases in said templates by physicians;
a process of selecting and placing medical, surgical, health and health-care data and information to relate to said words, terms and phrases by physicians;
a process of relating generated and selected medical, surgical, health and health-care data and information on patients by physicians to said words, terms and phrases in said templates;
a process of inputting and storing said related data and information and words, terms and phrases in the database or databases;
a process of relating said data and information to related words, terms, phrases, facts, texts, descriptions and writings on diseases, illnesses, disorders, health and health-care of patients;
a process of using said related data and information to retrieve related data and information and related words, terms, phrases, facts, texts, descriptions and writings on diseases, illnesses, disorders, health and health-care of patients for displays on the viewing screens; and
a process of retrieving and displaying related data and information and related words, terms, phrases, facts, texts, descriptions and writings on diseases, illnesses, disorders, health and health-care of patients for displays on the viewing screens.

4. A method of retrieving and displaying medical, surgical, health and health-care information store in the database or databases of computer, computers, server and/or servers in a network or networks of computers and servers to patients and physicians wherein the retrievals and displays of said information to said patients and physicians are the outcomes of a process of relating first words and terms in the first and second templates and second words, terms and phrases in the third templates comprising medical, surgical, health and health-care data and information generated by physicians and/or selected from the third templates of second words, terms and phrases display on the viewing screens of computers by physicians and wherein the outcomes of said selections and relations of said words, terms and phrases are used to effect the retrievals and displays of medical, surgical, health and health-care data and information on viewing screens for viewing by patients and physicians comprises:
a process of inserting words, terms and phrases representing medical, surgical, diseases, illnesses, disorders, health and health-care information and data into the database or databases of computer server or servers;
a process of storing words, terms and phrases representing medical, surgical, diseases, illnesses, disorders, health and health-care information and data in the database or databases of computer server or servers;
a process of creating template means for displaying said words, terms and phrases on the viewing screens;
a process of placing said words, terms and phrases in said template means for displaying said information and data;
a process of using said template means for means for displaying said words, terms and phrases by physicians;
a process of generating and relating medical, surgical, health and health-care data and information on patients to said words, terms and phrases in said templates by physicians;
a process of selecting and placing medical, surgical, health and health-care data and information to relate to said words, terms and phrases by physicians;
a process of relating generated and selected medical, surgical, health and health-care data and information on patients by physicians to said words, terms and phrases in said templates;
a process of inputting and storing said related data and information and words, terms and phrases in the database or databases;
a process of relating said data and information to related words, terms, phrases, facts, texts, descriptions and writings on diseases, illnesses, disorders, health and health-care of patients;
a process of using said related data and information to retrieve related data and information and related words, terms, phrases, facts, texts, descriptions and writings on diseases, illnesses, disorders, health and health-care of patients for displays on the viewing screens; and
a process of retrieving and displaying related data and information and related words, terms, phrases, facts, texts, descriptions and writings on diseases, illnesses, disorders, health and health-care of patients for displays on the viewing screens.
